(19) United States
(12) Patent Application Publication
(10) Pub. No.: US 2003/0085647 A1
(43) Pub. Date: May 8, 2003

(54) CRT panel glass high in x-ray absorbability and low in devitrification

(76) Inventors: Hiroshi Komori, Otsu-Shi (JP); Hiroki Yamazaki, Koga-Gun (JP)

Correspondence Address: COLLARD & ROE, P.C., 1077 Northern Boulevard, Roslyn, NY, 11576-1696, US

(21) Appl. No.: 09/921,973

(22) Filed: Aug. 2, 2001

(51) Int. Cl. H01J 31/00

(52) U.S. Cl. 313/477 R

(57) ABSTRACT

A CRT panel glass which does not substantially contain PbO, which contains, in mass percent, 45-60% SiO₂, 0-1% Al₂O₃, 0-3% MgO, 0-3% CaO, 5-11% SrO, 8-16% BaO, 6-8% ZnO, 1-6% Na₂O, 5-13% K₂O, 0.1-3% Li₂O, 0-1.5% ZrO₂, 0-3% TiO₂, 0-3% CeO₂, 0-2% Sb₂O₃, 0-2% P₂O₅, 0.30-0.45 SrO/(SrO+BaO) and, which has an X-ray absorption coefficient of 36.O cm⁻¹ or more at 0.6 Å.

### BACKGROUND OF THE INVENTION

This invention relates to a panel glass for use in connection with a CRT (cathode ray tube) of a color-television tube or a projection tube.

An envelope of a CRT comprises a panel portion for projecting video images, a tubular neck portion with an electron gun arranged therein, and a flare-shaped funnel portion connecting the panel portion and the neck portion. Electron beams emitted from the electron gun excite phosphors arranged on an inner surface of the panel portion to emit light so that the video images are projected on the panel portion. At this time, X-rays bremsstrahlung are produced inside the tube. If the X rays bremsstrahlung leak out of the tube through the envelope, an adverse influence is given to the human body. Therefore, the envelope of the type is required to have a high X-ray absorbability.

A panel glass is used for the panel portion. The panel glass used for the envelope of the CRT is generally referred to as a CRT panel glass.

In order to improve an X-ray absorption coefficient of the glass, PbO, SrO, BaO, ZnO, ZrO₂, and the like, may be contained in the glass. However, if the glass containing PbO is used for the panel glass, coloring called browning will occur due to the electron beams and X-ray irradiation which are produced upon projecting the video images. This results in a problem that the images can not be seen clearly.

In order to achieve the high X-ray absorption coefficient without containing PbO and to prevent the browning, proposal is made of a technique of making the glass contain a large amount of SrO, BaO, ZnO and ZrO₂. However, if the above-mentioned components are contained in the glass in a large amount, there arises a problem that the glass tends to be devitrified and a liquidus temperature rises to make the formation of the glass difficult. Herein, those substances which devitrify the glass will be referred to as devitrifying stones.

Japanese Unexamined Patent Publications (JP-A) Nos. S 63-215533 and H 3-12337 disclose CRT panel glasses reduced in devitrification and lowered in liquidus temperature by limiting the content of ZnO and ZnO₂.

However, in the CRT panel glass disclosed in Japanese Unexamined Patent Publications Nos. S 63-215533 and H 3-12337, the deposition temperature range is low for the devitrifying stones resulting from ZnO and ZnO₂ but the deposition temperature range is not low enough for the devitrifying stones resulting from other components. For example, when melting is performed in a melting furnace made of a SiO₂—Al₂O₃-based refractory material, it is impossible to suppress the production of the devitrifying stones such as a potash feldspar (K₂O·Al₂O₃·6SiO₂) and Leucite (K₂O·Al₂O₃·3SiO₂) which are produced at the interface between the refractory and the glass melt and to lower the deposition temperature (liquidus temperature) of the devitrifying stones such as barium disilicate (BaO·2SiO₂) or strontium silicate (SrO·SiO₂). Therefore, the above-mentioned devitrifying stones may be on an image display surface of the panel glass to cause defects so that the production yield is decreased.

### SUMMARY OF THE INVENTION

It is an object of the present invention to provide a CRT panel glass which is high in X-ray absorbability and low in devitrification.

It is a specific object of the present invention to provide a CRT which has an X-ray absorption coefficient not smaller than 36.0 cm⁻¹ at 0.6 Å, which can suppress production of devitrifying stones at an interface between a refractory and a glass melt, and which is substantially free from production of not only the devitrifying stones resulting from ZnO and ZrO₂ but also other devitrifying stones.

The present inventors repeatedly carried out a variety of experiments and, as a result, found a composition range for the CRT panel glass, which is capable of suppressing the devitrifying stones produced at the interface between the refractory and the glass melt and suppressing the increase in liquidus temperature due to presence of the devitrifying stones even if a large amount of SrO, BaO, ZnO, and ZrO₂ are contained in order to obtain a sufficient X-ray absorbability.

According to the present invention, there is provided a CRT panel glass which does not substantially contain PbO, which contains, in mass percent, 45-60% SiO₂, 0-1% Al₂O₃, 0-3% MgO, 0-3% CaO, 5-11% SrO, 8-16% BaO, 6-8% ZnO, 1-6% Na₂O, 5-13% K₂O, 0.1-3% Li₂O, 0-1.5% ZrO₂, 0-3% TiO₂, 0-3% CeO₂, 0-2% Sb₂O₃, 0-2% P₂O₅, 0.30-0.45 SrO/(SrO+BaO) and, which has an X-ray absorption coefficient of 36.0 cm⁻¹ or more at 0.6 Å.

The CRT glass of the present invention contains a large amount of SrO, BaO, ZnO, and ZrO₂ and therefore has an X-ray absorption coefficient of 36.0 cm⁻¹ or more at a wavelength of 0.6 Å even if PbO is not contained.

Generally, in case where a large amount of SrO, BaO, ZnO, and ZrO₂ are contained in the glass, devitrifying stones such as barium disilicate, strontium silicate, or wadeite (K₂O·ZrO₂·3SiO₂) tend to be produced. This results in a rise in liquidus temperature which makes the formation of the glass difficult. In the CRT glass of the present invention, production of the above-mentioned devitrifying stones can be suppressed and formation of the glass can be facilitated by the limitation of 5-11% SrO, 8-16% BaO, 6-8% ZnO, 0-1.5% ZrO₂, and 0.30-0.45 SrO/(SrO+BaO).

Moreover, by suppressing the content of Al₂O₃, which is a component of potash feldspar or Leucite, to 1.0% or less, it is possible to suppress the production of the devitrifying stones as reaction products even if the glass melt is in contact with SiO₂—Al₂O₃-based refractory for a long time.

Following is the reason for limiting the glass composition as mentioned above in the present invention.

PbO is a component which improves the X-ray absorbability of the glass. However, inclusion of PbO will cause coloring, which is called browning, by irradiation of electron beams and X-rays. Therefore, this component should not be introduced into the glass of this invention.

SiO₂ is a component serving as a network former of the glass. However, if the content is less than 45%, the viscosity of the glass is excessively lowered so that formation becomes difficult. The content of more than 60% leads to a coefficient of thermal expansion which is excessively low and will not match the coefficient of expansion of a funnel glass. Preferably, the content of SiO₂ is within the range of 50-58%.

Al₂O₃ also is a component serving as a network former of the glass. However, if the content is greater than 1%, the glass is easily devitrified. Reaction with the refractory produces the devitrifying stones as reaction products, such as Leucite or potash feldspar, resulting in decrease in productivity. Preferably, the content is not greater than 0.9%.

Each of MgO and CaO is a component serving to facilitate melting of the glass and to adjust the coefficient of thermal expansion and the viscosity. However, if the content is greater than 3%, the glass is easily devitrified and the liquidus temperature rises so that the formation becomes difficult. Preferably, the content of Al₂O₃ is not greater than 2%.

SrO is a component serving to facilitate the melting of the glass, to adjust the coefficient of thermal expansion and the viscosity, and to improve the X-ray absorbability. However, if the content is greater than 11%, the glass is easily devitrified and the liquidus temperature rises so that the formation becomes difficult. If the content is less than 5%, the X-ray absorbability is not sufficient. Preferably, the content of SrO is within the range of 6-10%.

BaO, like SrO, is also a component serving to facilitate the melting of the glass, to adjust the coefficient of thermal expansion and the viscosity, and to improve the X-ray absorbability. However, if the content is more than 16%, the glass is easily devitrified and the liquidus temperature rises so that the formation becomes difficult. If the content is less than 8%, the X-ray absorbability is not sufficient. Preferably, the content of BaO is within the range of 9-15%.

ZnO, like SrO and BaO, is a component serving to facilitate the melting of the glass, to adjust the coefficient of thermal expansion and the viscosity, and to improve the X-ray absorbability. However, if the content is more than 8%, the glass is easily devitrified and the liquidus temperature rises so that the formation becomes difficult. If the content is less than 6%, the X-ray absorbability is not sufficient. Preferably, the content of ZnO is within the range of 6.2-7.8%.

Na₂O is a component to adjust the coefficient of thermal expansion and the viscosity. If the content is more than 6%, the viscosity is excessively low so that the formation is difficult and the electrical resistivity is degraded. If the content is less than 1%, the coefficient of thermal expansion is excessively low and will not match the coefficient of expansion of the funnel glass. Preferably, the content of Na₂O is within the range of 2-5%.

K₂O, like Na₂O, is a component to adjust the coefficient of thermal expansion and the viscosity. If the content is smaller than 5%, the coefficient of thermal expansion is excessively low. If the content is greater than 13%, the electrical resistivity is degraded. Preferably, the content of K₂O is within the range of 6-12%

Li₂O, like Na₂O and K₂O, is a component to adjust the coefficient of thermal expansion and the viscosity. If the content is smaller than 0.1%, the coefficient of thermal expansion is excessively low. If the content is greater than 3%, the electrical resistivity is degraded. Preferably, the content of K₂O is within the range of 0.5-2.5%.

ZrO₂ is a component to adjust the coefficient of thermal expansion and the viscosity and to improve the X-ray absorbability. If the content is greater than 1.5%, wadeite is deposited and the formation becomes difficult. Preferably, the content of ZrO₂ is within the range of 0.1-1.4%.

TiO₂ is a component to suppress UV solarization of the glass. If the content is greater than 3%, the effect can not remarkably be improved and the material cost becomes high. Preferably, the content of TiO₂ is within the range of 0.1-2%.

CeO₂ is a component to suppress X-ray browning of the glass. If the content is greater than 3%, the glass will be colored and the sufficient optical transmittance can not be obtained. Preferably, the content of CeO₂ is within the range of 0.1-2%.

Sb₂O₃ can be used as a fining agent. However, if the content is greater than 2%, the effect can not remarkably be improved. Preferably, the content of Sb₂O₃ is 1% or less.

P₂O₅ can be added to suppress the tendency of devitrification. However, if the content is greater than 2%, separation of a liquid phase occurs and, inversely, devitrification will easily be caused. Preferably, the content of P₂O₅ is 1% or less.

In order to suppress the deposition of barium disilicate and strontium silicate and to lower the liquidus temperature, the ratio of SrO/(SrO+BaO) should be limited to 0.30-0.45. If the ratio is smaller than 0.30, barium disilicate is deposited so that the glass is devitrified and the liquidus temperature rises. If the ratio is greater than 0.45, strontium silicate is deposited so that the glass is devitrified and the liquidus temperature rises. The ratio of SrO/(SrO+BaO) is preferably within the range of 0.32-0.43.

### BRIEF DESCRIPTION OF THE DRAWINGS

Figure is a graph showing the relationship between SrO/(SrO+BaO) and the liquidus temperature.

### DESCRIPTION OF PREFERRED EMBODIMENT

Hereinbelow, a CRT panel glass according to the present invention will be described in detail in conjunction with examples.

Table 1 shows examples (Samples Nos. 1-4) according to the present invention and Table 2 shows comparative examples (Samples Nos. 5-9).

TABLE 1

Examples

| | 1 | 2 | 3 | 4 |
|---|---|---|---|---|
| composition (wt %) | | | | |
| SiO₂ | 55.5 | 55.4 | 52.5 | 56.0 |
| Al₂O₃ | 0.3 | 0.9 | — | 0.5 |
| MgO | — | 0.5 | 1.0 | — |
| CaO | — | 0.5 | — | 0.5 |
| SrO | 7.8 | 8.5 | 6.0 | 9.2 |
| BaO | 13.3 | 13.0 | 14.0 | 11.3 |
| ZnO | 7.0 | 6.0 | 7.8 | 7.5 |
| Na₂O | 3.4 | 2.8 | 4.0 | 3.5 |
| K₂O | 8.8 | 10.0 | 11.0 | 9.0 |
| Li₂O | 1.5 | 1.0 | 1.0 | 2.0 |
| ZrO₂ | 1.4 | 1.0 | 1.5 | — |
| TiO₂ | 0.3 | — | 0.4 | 0.1 |
| CeO₂ | 0.5 | — | 0.5 | 0.1 |
| Sb₂O₃ | 0.2 | 0.4 | 0.1 | 0.3 |
| P₂O₅ | — | — | 0.2 | — |
| SrO/(SrO + BaO) | 0.37 | 0.40 | 0.30 | 0.45 |
| X-ray absorption co- | 37.2 | 36.7 | 36.1 | 36.2 |
| efficient | | | | |
| (0.6 Å,cm-1) | | | | |
| Liquidus temperature | 840 | 844 | 843 | 854 |
| (° C.) | | | | |
| Wadeite Deposition Test | ◯ | ◯ | ◯ | ◯ |
| Reactivity with | ◯ | ◯ | ◯ | ◯ |
| Refractory | | | | |

TABLE 2

| | Examples | | | | |
|---|---|---|---|---|---|
| | 5 | 6 | 7 | 8 | 9 |
| composition (wt %) | | | | | |
| SiO₂ | 56.9 | 54.3 | 54.0 | 55.3 | 54.8 |
| Al₂O₃ | 0.5 | 0.8 | 0.3 | 0.3 | 1.1 |
| MgO | — | 0.5 | — | — | — |
| CaO | — | 0.5 | — | — | — |
| SrO | 10.0 | 6.0 | 7.8 | 7.8 | 7.8 |
| BaO | 11.5 | 15.0 | 13.3 | 13.3 | 13.3 |
| ZnO | 6.0 | 8.0 | 8.5 | 7.0 | 7.0 |
| Na₂O | 3.5 | 3.0 | 3.4 | 3.4 | 3.4 |
| K₂O | 9.0 | 7.5 | 8.8 | 8.8 | 8.8 |
| Li₂O | 1.0 | 1.9 | 1.5 | 1.5 | 1.5 |
| ZrO₂ | 1.0 | 1.5 | 1.4 | 1.6 | 1.4 |
| TiO₂ | 0.2 | 0.1 | 0.3 | 0.3 | 0.3 |
| CeO₂ | 0.3 | 0.8 | 0.5 | 0.5 | 0.5 |
| Sb₂O₃ | 0.1 | 0.1 | 0.2 | 0.2 | 0.1 |
| P₂O₅ | — | — | — | — | — |
| SrO/(SrO + BaO) | 0.47 | 0.28 | 0.37 | 0.37 | 0.37 |
| X-ray absorption | 37.7 | 36.1 | 38.2 | 37.4 | 37.1 |
| co-efficient | | | | | |
| (0.6 Å, cm-1) | | | | | |
| Liquidus temperature | 865 | 875 | 862 | 842 | 841 |
| (° C.) | | | | | |
| Wadeite Deposition Test | ◯ | ◯ | ◯ | X | ◯ |
| Reactivity with | ◯ | ◯ | ◯ | ◯ | X |
| Refractory | | | | | |

Each of the samples given in Tables 1 and 2 was prepared in the following manner.

A batch prepared to have a glass composition as defined in the Tables 1 and 2 was put into a platinum crucible and melted at about 1500° C. for 4 hours. In order to obtain a uniform or homogeneous glass, degassing was performed by stirring using a platinum stirring bar for three minutes. Thereafter, the molten glass was formed into a predetermined shape and thereafter gradually cooled.

For each sample obtained as mentioned above, the X-ray absorption coefficient, the liquidus temperature, evaluation of wadeite deposition, and evaluation of the reactivity with refractory were examined and the results are shown in the Tables 1 and 2.

The X-ray absorption coefficient is obtained by calculating the absorption coefficient at 0.6 angstroms with reference to the glass composition and the density.

The liquidus temperature was measured in the following manner. Each sample was pulverized into the size of 300-500 μm, mixed, put into a platinum boat, transferred into a gradient heating furnace to be held at 750-1050° C. for 48 hours. Then, the platinum boat was taken out from the gradient heating furnace. Thereafter, the glass was taken out from the platinum boat. The sample thus obtained was observed by the use of a polarizing microscope to measure the crystal deposition point.

Evaluation of wadeite deposition and evaluation of the refractor reactivity were carried out in the following manner. First, each of the samples and a SiO₂-Al₂O₃-based refractory were pulverized into the size of 300-500 μm, mixed, put into a platinum boat to be heated at 1000° C. for 2 hours. Next, the boat was transferred into the gradient heating furnace kept at 800-1100° C. to be held for 96 hours. Then, the platinum boat was taken out from the gradient heating furnace. Thereafter, the glass was taken out from the platinum boat. The samples of the refractory reaction test thus obtained were processed into thin pieces and observed by the polarizing microscope. ◯ represents the sample in which no stones were observed while X represents the sample in which stones such as wadeite, potash feldspar, or Leucite were observed.

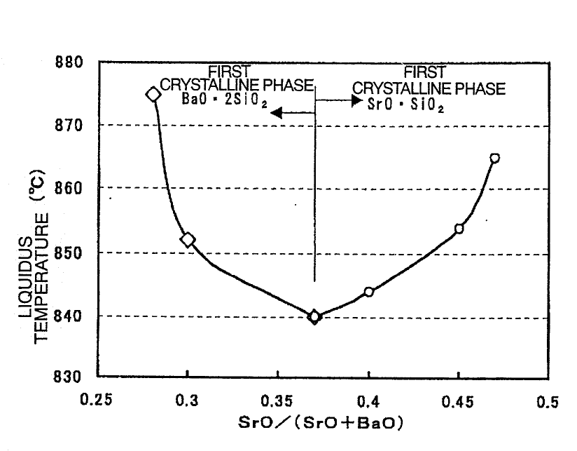

Referring to FIG. 1, description will hereinafter be made about the relationship between SrO/(SrO+BaO) and the liquidus temperature. In FIG. 1, an ordinate shows the liquidus temperature while an abscissa shows the ratio of SrO/(SrO+BaO). ⋄ represents occurrence of deposition of barium disilicate in a first crystalline phase while ◯ represents occurrence of deposition of strontium silicate in the first crystalline phase. The glass of Sample No. 1 was used as a mother glass composition.

When the value of SrO/(SrO+BaO) is equal to 0.37, the first crystalline phase contains two kinds of crystals including barium disilicate and the liquidus temperature exhibits the minimum value. When the value of SrO/(SrO+BaO) becomes greater than 0.37, strontium silicate is deposited in the first crystalline phase and the liquid temperature rises. Even when the value of SrO/(SrO+BaO) becomes smaller than 0.37 on the contrary, barium disilicate is deposited in the first crystalline phase and the liquidus temperature rises.

Next, description will be made about the characteristics of the glass obtained as mentioned above.

As is apparent from Table 1, each of Samples Nos. 1-4 has a high X-ray absorption coefficient not smaller than 36.1 cm⁻¹ and has a low liquidus temperature of 854° C. or less because of the limitation within the range of 5-11% SrO, 8-16% BaO, 6-8% ZnO, 0-1.5% ZrO₂, 0.30-0.45 SrO/(SrO+BaO). Since the content of Al₂O₃ is not greater than 1.0%, the devitrifying stones as the reaction products, such as potash feldspar or Leucite were not produced.

As is apparent from Table 2, the values of SrO/(SrO+BaO) in Samples Nos. 5 and 6 are equal to 0.47 and 0.28, respectively. Therefore, the liquidus temperature was as high as 865° C. or more. In Sample No. 7, the content of ZnO is equal to 8.5% so that the liquidus temperature was as high as 865° C. In Sample No. 8, the liquidus temperature was low. However, wadeite was deposited because the content of ZrO₂ is equal to 1.6%. In Sample No. 9, the liquidus temperature is low. However, the devitrifying stones as the reaction products, such as a potash feldspar or Leucite, was produced because the content of Al₂O₃ is equal to 1.1%.

As described above, the glass according to the present invention has a high X-ray absorption coefficient of 36.0 cm⁻¹ or more, is suppressed in production of the devitrifying stones resulting from reaction with the refractory, and is easy in melting and formation because the liquidus temperature is low. Therefore, the glass is suitable as a CRT panel glass for use in a color television tube or a projection tube.

What is claimed is:

1. A CRT panel glass which does not substantially contain PbO, which contains, in mass percent, 45-60% SiO₂, 0-1% Al₂O₃, 0-3% MgO, 0-3% CaO, 5-11% SrO, 8-16% BaO, 6-8% ZnO, 1-6% Na₂O, 5-13% K₂O, 0.1-3% Li₂O, 0-1.5% ZrO₂, 0-3% TiO₂, 0-3% CeO₂, 0-2% Sb₂O₃, 0-2% P₂O₅, 0.030-0.45 SrO/(SrO+BaO) and, which has an X-ray absorption coefficient of 36.0 cm⁻¹ or more at 0.6 Å.

2. A CRT panel glass as claimed in claim 1, wherein the content of SiO₂ is 50-58%.

3. A CRT panel glass as claimed in claim 1, wherein the content of Al₂O₃ is 0.9% or less.

4. A CRT panel glass as claimed in claim 1, wherein the content of each of MgO and CaO is 2% or less.

5. A CRT panel glass as claimed in claim 1, wherein the content of SrO is 6-10%.

6. A CRT panel glass as claimed in claim 1, wherein the content of BaO is 9-15%.

7. A CRT panel glass as claimed in claim 1, wherein the content of ZnO is 6.2-7.8%.

8. A CRT panel glass as claimed in claim 1, wherein the content of Na₂O is 2-5%.

9. A CRT panel glass as claimed in claim 1, wherein the content of K₂O is 6-12%.

10. A CRT panel glass as claimed in claim 1, wherein the content of Li₂O is 0.5-2.5%.

11. A CRT panel glass as claimed in claim 1, wherein the content of ZrO₂ is 0.1-1.4%.

12. A CRT panel glass as claimed in claim 1, wherein the content of TiO₂ is 0.1-2%.

13. A CRT panel glass as claimed in claim 1, wherein the content of CeO₂ is 0.1-2%.

14. A CRT panel glass as claimed in claim 1, wherein the content of Sb₂O₃ is 1% or less.

15. A CRT panel glass as claimed in claim 1, wherein the content of P₂O₅ is 1% or less.

16. A CRT panel glass as claimed in claim 1, wherein the ratio of SrO/(SrO+BaO) is 0.32-0.43.
